(19) United States
(12) Patent Application Publication
(10) Pub. No.: US 2018/0154506 A1
(43) Pub. Date: Jun. 7, 2018

(54) Hammer Raising Device

(71) Applicant: SHINWOO HEAVY INDUSTRY CO., LTD., Chilgok-gun (KR)

(72) Inventor: Jong Jik LEE, Seoul (KR)

(21) Appl. No.: 15/888,509

(22) Filed: Feb. 5, 2018

Related U.S. Application Data
(63) Continuation-in-part of application No. 14/406,567, filed on Dec. 9, 2014.

(30) Foreign Application Priority Data
Jun. 14, 2012 (KR) 10-2012-0063876

(51) Int. Cl. B25D 9/26; B25D 9/12

(52) U.S. Cl. CPC B25D 9/26; E02D 7/10; B25D 9/12

(57) ABSTRACT

Provided a hammer raising device configured to increase striking intensity by eliminating fluid resistance when a piston raised upward moves downward. To achieve this, the hammer raising device includes a hydraulic control valve that controls a supply of a fluid, a sub cylinder to which the fluid is supplied by an operation of the hydraulic control valve, a sub piston that is partially accommodated within the sub cylinder, and is raised or lowered by the fluid, a main piston that comes in close contact with a longitudinal end of the sub piston to be raised by the raising of the sub piston, and is lowered when the closely contacted longitudinal end of the sub piston is separated, and a main cylinder that accommodates the main piston.

### CROSS-REFERENCE TO RELATED APPLICATIONS

The instant application is a continuation-in-part application of U.S. patent application Ser. No. 14/406,567 filed on Dec. 9, 2014, which is a national-stage application under 35 USC § 371 based on PCT Application No. PCT/KR2013/005180 filed on Jun. 12, 2013, and claims priority to Korean patent application No. 10-2012-0063876 filed on Jun. 14, 2012, the entire disclosures of which are hereby incorporated by reference.

### TECHNICAL FIELD

The present invention relates to a hammer raising device, and more particularly, to a hammer raising device capable of increasing striking intensity of a piston by eliminating fluid resistance within a main cylinder and the piston when the piston raised upward is lowered downward.

### BACKGROUND ART

In general, a hammer refers to a device that is attached to equipment such as a loader or an excavator having a hydraulic pump, controls a high-pressure fluid supplied form the hydraulic pump by a predetermined flow path and a valve, raises and lowers a piston provided within the hydraulic hammer to strike a tool, and allows the tool to crush a rock bed or a concrete ground due to a reaction force.

FIG. 1 shows a hydraulic hammer according to the related art. Hereinafter, a configuration and an operation of the hydraulic hammer according to the related art will be described in detail with reference to FIG. 1.

Referring to FIG. 1, the hydraulic hammer includes a valve, an accumulator, a cylinder, a piston, and a charging-gas storage. Naturally, it is apparent that other configurations other than the aforementioned configurations may be included in the hydraulic hammer.

When a valve 100 is open, a high-pressure fluid supplied from a hydraulic pump is introduced into a cylinder 102. When the high-pressure fluid is introduced to an inside 99 of the cylinder 108, a piston 102 accommodated within a cylinder 108 is raised by a pressure of the introduced fluid.

As shown in FIG. 1, the piston 102 has a cylindrical shape, and has a shape whose central portion protrudes. The cylinder 108 has a vent hole for accommodating the piston 102, and induces a vertical movement of the piston 102. Further, a diameter of the vent hole of the cylinder 108 is not uniform such that the piston 102 having the shape whose central portion protrudes can vertically move within a predetermined range. That is, the vent hole of the cylinder is formed such that a region of the vent hole where the protruding portion of the piston 102 vertically moves has a diameter larger than that of another region of the vent hole. Naturally, in the hydraulic hammer, it is most important to completely seal a gap between the piston 102 and the cylinder 108 such that the high-pressure fluid does not leak to the outside through the gap between the piston 102 and the cylinder 108.

A gas stored in a charging-gas storage 106 formed at an upper part of the cylinder is slowly compressed by the raising of the piston 102. When the piston 102 is raised to a predetermined position by the fluid pressure, the valve 100 is closed, and the piston moves downward by a weight of the piston 102 and a force of the compressed gas in the charging-gas storage 106.

In this case, the fluid located between the cylinder and the piston moves to an accumulator 104. As described above, the hydraulic hammer according to the related art crushes a rock bed or a concrete bed by repeating the aforementioned operations.

Unfortunately, in the hydraulic hammer according to the related art, a sealing member is provided at a lower end so as not to allow the high-pressure fluid to leak into the gap between the piston and the cylinder, and, thus, an acceleration of the cylinder moving downward due to friction between the piston and the cylinder is decreased. Furthermore, a sealing member 88 which is located at the lower end as the sealing member for sealing the piston and the cylinder may be damaged due to the friction, and in order to maintain a desired sealing state, the damaged member needs to be periodically replaced with new one.

Moreover, when the piston moves downward, since the fluid existing in the inside 99 of the cylinder needs to be instantaneously discharged to the accumulator 104, striking intensity of the piston is remarkably reduced due to resistance generated in such a case.

### DISCLOSURE

### Technical Problem

An object of the present invention is to provide a method of increasing striking intensity of a piston by decreasing a frictional force between the piston and a cylinder to increase an acceleration of the piston moving downward.

Another object of the present invention is to provide a method capable of reducing management cost since a sealing member formed at a lower end to seal a gap between the piston and the cylinder is not used.

Still another object of the present invention is to provide a method of additionally preventing an overheating phenomenon between the cylinder and the piston without using a large-sized drain pipe for reducing resistance at a drain line.

### Technical Solution

To achieve this, according to one embodiment of the present disclosure, a hammer raising device is provided. The hammer raising device includes a sub cylinder to which a fluid is supplied by an operation of a hydraulic control valve, a sub piston that is partially accommodated within the sub cylinder, and is raised or lowered by the fluid, a main piston that comes in close contact with a longitudinal end of the sub piston to be raised by the raising of the sub piston, and is lowered when the closely contacted longitudinal end of the sub piston is separated, a main cylinder that accommodates the main piston, and a switching valve that separates the sub piston from the main piston by closing the hydraulic control valve when the main piston reaches a maximum point where the main piston is able to move within the main cylinder. The sub piston includes a first sub piston, and a second sub piston, and the first sub piston and the second sub piston alternately raises the main piston. A main piston detection unit sensing whether or not the main piston reaches a maximum point where the main piston is able to move within the main cylinder. The switching valve separates the sub piston from the main piston by receiving sensing signal from the main piston detection unit and closing the hydraulic control valve when the main piston reaches the maximum point. A gas stored in a charging-gas storage defined at an upper part of the main cylinder is compressed when the main piston raises. When the sub piston is separated from the main cylinder, the main piston moves downward by a weight of the main piston and a force of the compressed gas stored in the charging-gas storage. When the main piston moves downward, no sealing member is disposed between the main piston and the main cylinder. The switching vale is operatively connected to both the sub piston and the hydraulic control valve. The sub piston includes a plurality of sub pistons, and each of the plurality of sub pistons alternately raises the main piston

### Effect of the Invention

In the hammer raising device according to the present invention, since a main piston provided within a main cylinder is raised using the piston and the cylinder provided outside without introducing a fluid into the main cylinder, a separate sealing member is not used between the main cylinder and the main piston. In this way, since the separate sealing member is not used, it is possible to prevent an acceleration from being decreased due to resistance caused by a frictional force between the main cylinder and the main piston. Further, since the main piston is raised using a plurality of sub pistons, it is possible to increase the number of times of striking of the piston.

In addition, in the hammer device according to the present invention, it is possible to freely adjust a movement range of the main piston for striking. That is, in the existing hammer device, it is necessary to introduce the fluid into the main cylinder, and it is necessary to increase the amount of the introduced fluid depending on the movement range of the main piston. However, in the hammer device according to the present invention, since the sub piston is used without introducing the fluid into the main cylinder, it is possible to freely adjust the movement range.

### DESCRIPTION OF DRAWINGS

FIG. 1 shows a hydraulic hammer according to the related art.

FIG. 2 shows a hammer device according to an embodiment of the present invention.

FIG. 3 shows a hammer device according to another embodiment of the present invention.

FIGS. 4A to 4C show a structure of a main-piston raising device according to the embodiment of the present invention.

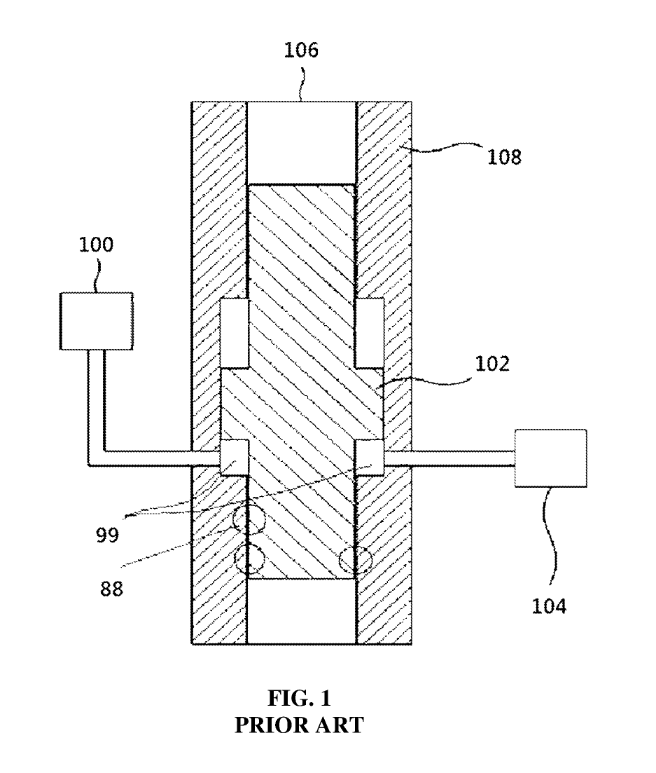

### BEST MODE

The aforementioned and additional aspects of the present invention will become more apparent through preferred embodiments described with reference to the accompanying drawings. Hereinafter, the embodiments of the present invention will be described in detail to allow those skilled in the art to easily understand and implement the present invention.

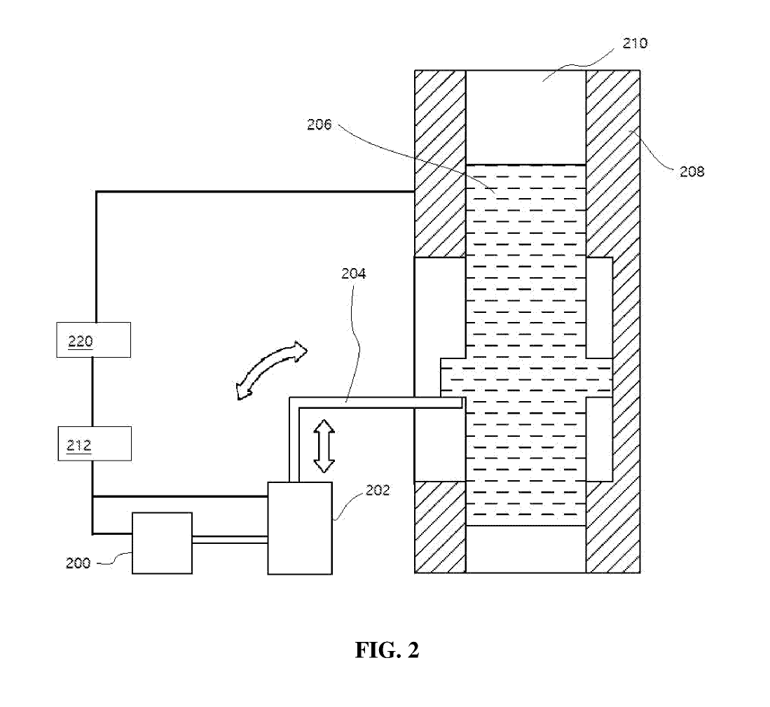

FIG. 2 shows a hammer device according to an embodiment of the present invention. The hammer device according to the embodiment of the present invention will be now described in detail with reference to FIG. 2.

Referring to FIG. 2, the hammer device includes a hydraulic control valve, a main cylinder, a main piston, a sub cylinder, a sub piston, and a charging-gas storage. Naturally, it is apparent that other configurations other than the aforementioned configurations are included in the hammer device.

A hydraulic control valve 200 controls movement of a high-pressure fluid supplied from a hydraulic pump. When the hydraulic control valve 200 is open, the fluid supplied from the hydraulic pump is supplied to a sub cylinder 202. The high-pressure fluid supplied to the sub cylinder 202 raises a sub piston 204 within the sub cylinder 202. The sub piston 204 comes in close contact with a lower end of a protruding portion of a main piston 206, and the main piston 206 is also raised by the raising of the sub piston 204.

The main piston 206 has a cylindrical shape, and has a shape whose central portion protrudes. A main cylinder 208 has a vent hole for accommodating the main piston 206 therein, and induces a vertical movement of the main piston 206.

Further, a diameter of the vent hole is not uniform such that the main piston 206 having the shape (protruding portion) whose central portion protrudes can vertically move within a predetermined range. That is, a region of the vent hole where the protruding portion of the main piston 206 vertically moves has a diameter larger than that of another region of the vent hole. A range of the vertical movement of the main piston 206 within the main cylinder 208 may be variously changed depending on an intention of a manufacturer. In the present invention, since the main piston is raised using the sub piston, a lower-end sealing member is not needed between the main piston and the main cylinder.

A gas stored in a charging-gas storage 210 formed at an upper part of the main cylinder 208 is compressed by the raising of the main piston 206. When the main piston 206 is raised to a predetermined position within the main cylinder 208, a switching valve 212 is operated. The sub piston 204 is separated from a lower end of the main piston 206 by the operation of the switching valve 212, and when the sub piston 204 is separated, the main piston 206 moves downward by a weight of the main piston 206 and a force of the compressed gas stored in the charging-gas storage 210. Naturally, when the switching valve is operated, the hydraulic control valve 200 is simultaneously closed. In this case, a frictional force is not generated between the main piston 206 and the main cylinder 208 as described above, and, thus, an acceleration of the main cylinder moving downward is more increased than that in the related art. The switching vale 212 is operatively connected to both the sub piston 204 and the hydraulic control valve 200. The switching valve 212 operates to withdraw the sub piston 204 from the side wall of the main cylinder 208. When the switching valve operates to effect a withdrawal of sub piston 204 from the wall of the main cylinder 208, the sub piston 204 is no longer forcefully engaged against the underside of the enlarged portion of the main piston 206, but instead is in free fall.

Furthermore, since the range of the vertical movement of the main piston within the main cylinder can be variously changed depending on the intention of the manufacturer as described above, it is possible to increase striking intensity due to the main piston by increasing the movement range when necessary. In contrast, the hydraulic hammer according to the related art has a demerit in that a size of the accumulator and the amount of the supplied fluid need to be increased in order to adjust the range of the vertical movement of the piston within the cylinder.

The sub piston 204 separated from the main piston 206 moves downward, and the sub piston moved downward raises the main piston.

It has been illustrated in FIG. 2 that the main piston has the shape whose central portion protrudes, but the present invention is not limited thereto. That is, a groove having a predetermined depth is formed at the central portion of the main piston, and the sub piston can raise the main piston by using the formed groove.

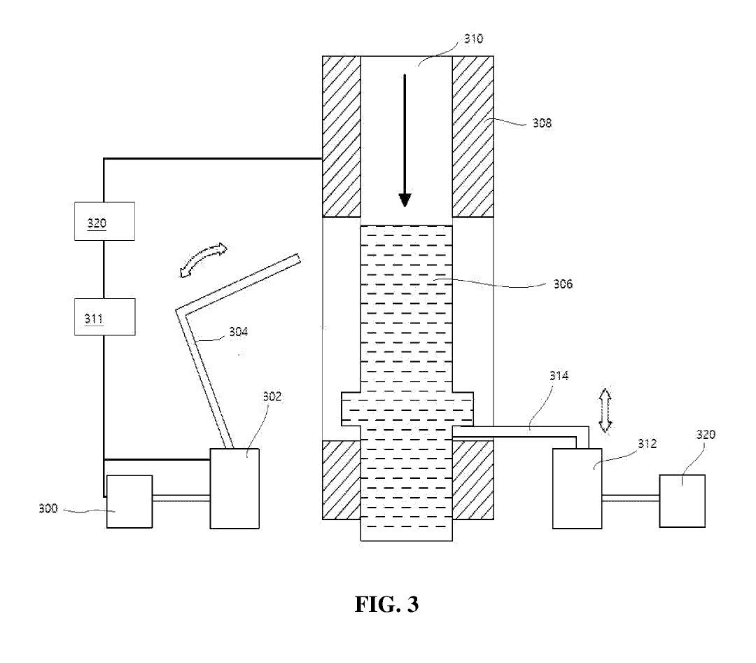

FIG. 3 shows a hammer device according to another embodiment of the present invention. The hammer device according to the another embodiment of the present invention will be now described in detail with reference to FIG. 3.

Referring to FIG. 3, the hammer device includes a first hydraulic control valve 300, a second hydraulic control valve 320, a main cylinder 308, a main piston 306, a first sub cylinder 302, a second sub cylinder 312, a first sub piston 304, a second sub piston 314, and a charging-gas storage 310. Naturally, it is apparent that other configurations other than the aforementioned configurations are included in the hammer device.

A first hydraulic control valve 300 controls supplying of a high-pressure fluid supplied from a hydraulic pump to a first sub cylinder 302. A second hydraulic control valve 320 controls supplying of the high-pressure fluid supplied from the hydraulic pump to a second sub cylinder 312.

When the first hydraulic control valve 300 is open, the fluid supplied from the hydraulic pump is supplied to the first sub cylinder 302. When the second hydraulic control valve 320 is open, the fluid supplied from the hydraulic pump is supplied to the second sub cylinder 312. In the present invention, the first hydraulic control valve 300 and the second hydraulic control valve 320 are not simultaneously open but are alternately open.

The high-pressure fluid supplied to the first sub cylinder 302 raises a first sub piston 304 within the first sub cylinder 302. The first sub piston 304 comes in close contact with a lower end of a protruding portion of a main piston 306, and the main piston is also raised by the raising of the first sub piston 304.

A gas stored in a charging-gas storage 310 formed at an upper part of a main cylinder 308 is compressed by the raising of the main piston 306. When the main piston 306 is raised to a predetermined position, a first switching valve 312 is operated. The first sub piston 304 is separated from a lower end of the main piston 306 by the operation of the first switching valve 311, and when the first sub piston 304 is separated, the main piston 306 moves downward by a weight of the main piston 306 and a force of the compressed gas stored in the charging-gas storage 310. Naturally, when the first switching valve 311 is operated, the first hydraulic control valve 300 is simultaneously closed.

The second sub cylinder 312, a second sub piston 314, and a second switching valve (not shown) perform the same operations as those of the first sub cylinder 302, the first sub piston 304, and the first switching valve. Naturally, as described above, a first drive unit including the first sub cylinder 302, the first sub piston 304 and the first switching valve 311 and a second drive unit including the second sub cylinder 312, the second sub piston 314 and the second switching valve do not perform the same operation at the same point of time but alternately perform the operations at a regular period. In this way, by using the plurality of driving units, it is possible to increase the number of times of the vertical movement of the main piston. That is, before the main piston is lowered to reach a minimum point, at least one sub piston of the first sub piston 304 and the second sub piston 314 moves to reach the minimum point, so that it is possible to increase the number of times of the vertical movement of the main piston.

It is illustrated in FIG. 3 that two hydraulic control valves are provided, but the present invention is not limited thereto. That is, two sub pistons may be operated using one hydraulic control valve.

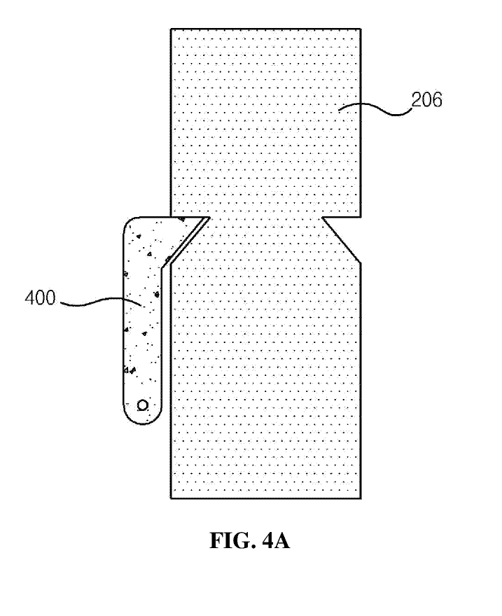

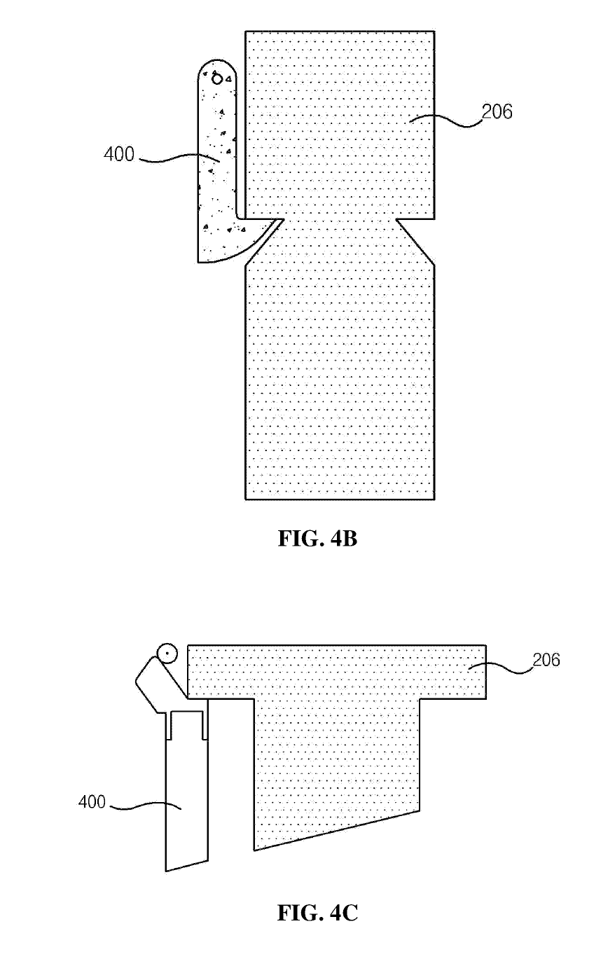

FIGS. 4A to 4C show methods of raising the main piston depending on a structure thereof according to the embodiment of the present invention. The raising method according the structure of the main piston according to the embodiment of the present invention will be now described in detail wither reference to FIG. 4.

Referring to FIG. 4A, the main piston has a groove, and a main-piston raising device 400 comes in close contact with the groove. The main-piston raising device 400 is connected to a longitudinal end of the sub piston. The main-piston raising device 400 is located on a lower side where the groove is formed, and the main piston is raised by the raising of the main-piston raising device 400. When the main piston reaches a maximum point, the switching valve 212 separates the main-piston raising device 400 from the main piston and is detected by a main piston detection unit shown as elements 220 and 320 in FIGS. 2 and 3, respectively.

Referring to FIG. 4B, the main piston has the groove, and the main-piston raising device comes in close contact with the groove. The main-piston raising device 400 is connected to the longitudinal end of the sub piston. The main-piston raising device 400 is located on an upper side where the groove is formed, and the main piston is raised by the raising of the main-piston raising device 400. When the main piston reaches the maximum point as detected by the main piston detection unit 220 and 320, the switching valve separates the main-piston raising device 400 from the main piston.

Referring to FIG. 4C, the main piston has a “T” shape, and the main-piston raising device 400 comes in close contact with a lower end of the “T” shape. The main-piston raising device 400 is connected to the longitudinal end of the sub piston. The main-piston raising device is located at the lower end of the “T” shape, and the main piston is raised by the raising of the main-piston raising device. When the main piston reaches the maximum point, the main-piston raising device 400 is automatically separated from the main piston.

Although the present invention has been described in conjunction with the embodiments illustrated in the drawings, the embodiments are merely examples. It should be understood to those skilled in the art that various modifications and other equivalent embodiments are possible.

1. A hammer raising device comprising:
a sub cylinder to which a fluid is supplied by an operation of a hydraulic control valve;
a sub piston that is partially accommodated within the sub cylinder, and is raised or lowered by the fluid;
a main piston that comes in close contact with a longitudinal end of the sub piston to be raised by the raising of the sub piston, and is lowered when the closely contacted longitudinal end of the sub piston is separated;
a main cylinder that accommodates the main piston; and
a switching valve that separates the sub piston from the main piston by closing the hydraulic control valve when the main piston reaches a maximum point where the main piston is able to move within the main cylinder.

2. The hammer raising device of claim 1,
wherein the sub piston includes a first sub piston, and a second sub piston, and
the first sub piston and the second sub piston alternately raises the main piston.

3. The hammer raising device of claim 1, wherein a main piston detection unit sensing whether or not the main piston reaches a maximum point where the main piston is able to move within the main cylinder.

4. The hammer raising device of claim 3, wherein the switching valve separates the sub piston from the main piston by receiving sensing signal from the main piston detection unit and closing the hydraulic control valve when the main piston reaches the maximum point.

5. The hammer raising device of claim 1, wherein a gas stored in a charging-gas storage defined at an upper part of the main cylinder is compressed when the main piston raises.

6. The hammer raising device of claim 5, wherein when the sub piston is separated from the main cylinder, the main piston moves downward by a weight of the main piston and a force of the compressed gas stored in the charging-gas storage.

7. The hammer raising device of claim 5, wherein when the main piston moves downward, no sealing member is disposed between the main piston and the main cylinder.

8. The hammer raising device of claim 1, wherein the switching vale is operatively connected to both the sub piston and the hydraulic control valve.

9. The hammer raising device of claim 1, wherein the sub piston includes a plurality of sub pistons, and each of the plurality of sub pistons alternately raises the main piston.
